(19) United States
(12) Patent Application Publication
(10) Pub. No.: US 2023/0136684 A1
(43) Pub. Date: May 4, 2023

(54) PERSON MOVEMENT TYPE DETERMINATION METHOD, PERSON MOVEMENT TYPE DETERMINATION DEVICE, AND STORAGE MEDIUM

(71) Applicant: TOYOTA JIDOSHA KABUSHIKI KAISHA, Toyota-shi Aichi-ken (JP)

(72) Inventor: Shin Tanaka, Numazu-shi Shizuoka-ken (JP)

(73) Assignee: TOYOTA JIDOSHA KABUSHIKI KAISHA, Toyota-shi Aichi-ken (JP)

(21) Appl. No.: 17/943,662

(22) Filed: Sep. 13, 2022

(30) Foreign Application Priority Data
Nov. 1, 2021 (JP) 2021-179073

(51) Int. Cl. G06V 10/77; G06V 10/764; G06V 40/20; G06V 20/58

(52) U.S. Cl. CPC G06V 10/7715; G06V 10/764; G06V 40/25; G06V 20/58

(57) ABSTRACT

A person movement type determination method includes: acquiring time-series data of a position or a speed of a predetermined feature portion which is a part of a body of a target person; extracting a feature value of a predetermined frequency component or a predetermined frequency band based on oscillation of the predetermined feature portion indicating a movement type to be determined from the time-series data; and determining whether a movement type of the target person is that which is to be determined based on the feature value.

### CROSS-REFERENCE TO RELATED APPLICATION

This application claims priority to Japanese Patent Application No. 2021-179073 filed on Nov. 1, 2021, incorporated herein by reference in its entirety.

### BACKGROUND

### 1. Technical Field

The disclosure relates to a person movement type determination method, a person movement type determination device, and a storage medium.

### 2. Description of Related Art

A device that identifies a region including a person in an image, determines that the person is a pedestrian when a right area proportion and a left area proportion of the region are changing periodically, and determines that the person is moving by bicycle otherwise is disclosed in Japanese Unexamined Patent Application Publication No. 2016-186780 (JP 2016-186780 A).

### SUMMARY

In the device described in JP 2016-186780 A, it is necessary to repeat identifying the entire region including a person in an image and calculating the right area proportion and the left area proportion of the region on a plurality of images captured with the elapse of time, and thus a processing load is enlarged. When a part of the person is covered with a certain object, the region including the person may not appear satisfactorily in the image and it may be difficult to determine whether the right area proportion and the left area proportion are changing periodically.

The disclosure provides a person movement type determination method, a person movement type determination device, and a storage medium that appropriately determine a movement type of a person.

According to a first aspect of the disclosure, there is provided a person movement type determination method including: acquiring time-series data of a position or a speed of a predetermined feature portion which is a part of a body of a target person; extracting a feature value of a predetermined frequency component or a predetermined frequency band based on oscillation of the predetermined feature portion indicating a movement type to be determined from the time-series data; and determining whether a movement type of the target person is that which is to be determined based on the feature value.

With the first aspect, the movement type of the target person can be determined based on a feature value of the predetermined frequency component or the predetermined frequency band based on oscillation of the predetermined feature portion. Unlike in the related art, since the predetermined feature portion which is a part of the target person is detected instead of performing image processing on the entire region in which the person appears, it is possible to reduce a processing load for determining the movement type. Even when a part of the target person is covered with a certain object but a predetermined feature portion such as a head is not covered therewith, it is possible to determine the movement type. Accordingly, according to the first disclosure, it is possible to appropriately determine the movement type of the person.

According to a second aspect of the disclosure, there is provided a person movement type determination device including: an acquisition unit configured to acquire time-series data of a position or a speed of a predetermined feature portion which is a part of a body of a target person; an extraction unit configured to extract a feature value of a predetermined frequency component or a predetermined frequency band based on oscillation of the predetermined feature portion indicating a movement type to be determined from the time-series data; and a determination unit configured to determine whether a movement type of the target person is that which is to be determined based on the feature value.

According to a third aspect of the disclosure, there is provided a storage medium that stores a person movement type determination program causing a computer to perform: acquiring time-series data of a position or a speed of a predetermined feature portion which is a part of a body of a target person; extracting a feature value of a predetermined frequency component or a predetermined frequency band based on oscillation of the predetermined feature portion indicating a movement type to be determined from the time-series data; and determining whether a movement type of the target person is that which is to be determined based on the feature value.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle 1 according to an embodiment of the disclosure;

FIG. 2A is a diagram illustrating a movement type and a feature portion of a target person 4;

FIG. 2B is a diagram illustrating a movement type and a feature portion of a target person 4;

FIG. 3A is a diagram illustrating time-series data which is acquired by a time-series data acquiring unit 102;

FIG. 3B is a diagram illustrating time-series data which is acquired by the time-series data acquiring unit 102;

FIG. 4A is a diagram illustrating a frequency component which is acquired by a feature value extracting unit 103;

FIG. 4B is a diagram illustrating a frequency component which is acquired by the feature value extracting unit 103;

FIG. 4C is a diagram illustrating a frequency component which is acquired by the feature value extracting unit 103;

FIG. 4D is a diagram illustrating a frequency component which is acquired by the feature value extracting unit 103;

FIG. 5 is a flowchart illustrating a routine of processes;

FIG. 6 is a table illustrating a magnitude of a threshold value which is set by a driving support device 3; and

FIG. 7 is a flowchart illustrating a routine of processes when the order of determinations has changed according to a modified example.

### DETAILED DESCRIPTION OF EMBODIMENTS

### Embodiment

Hereinafter, an embodiment of the disclosure will be described with reference to the accompanying drawings.

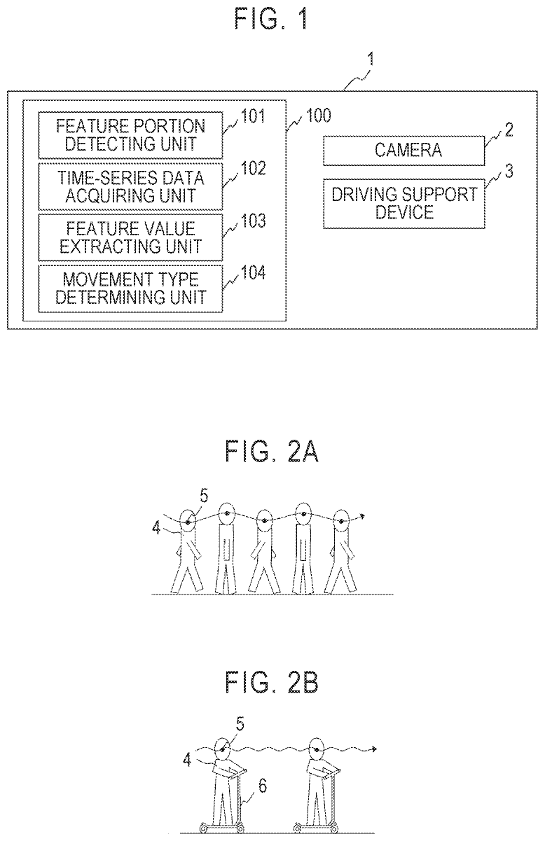

A vehicle 1 illustrated in FIG. 1 includes a movement type determination device 100, a camera 2, and a driving support device 3. The vehicle 1 is configured to allow the driving support device 3 to realize a driving support function of supporting at least one of driving, steering, and braking. For example, the vehicle 1 may be an automated-driving vehicle which is classified into Level 2 or higher in the definition of automated driving levels in the Society of Automotive Engineers (SAE).

The movement type determination device 100 is a device that determines a movement type of a person near the vehicle. Specifically, the movement type determination device 100 determines whether a person near the vehicle is in a state in which the person is walking or in a state in which the person is riding on a vehicle. The movement type determination device 100 determines whether a person is in a state in which the person is riding on a vehicle using a pedaling motion of the person as power. In the vehicle 1, driving support is performed by the driving support device 3, and a movement type of a person near the vehicle needs to be determined to effectively perform the driving support. For example, when a person is walking, a moving speed of the person is about 5 km/h. On the other hand, when a person is riding on a vehicle, a moving speed of the person is higher than 5 km/h. For example, when a person is riding on an electric scooter, a moving speed of the person is about 30 km/h. The moving speed when a person is riding on a vehicle using a pedaling motion of the person as power is lower than moving speeds of vehicles using other power. For example, when a person is riding on a bicycle, a moving speed of the person is about 20 km/h. That is, the moving speed increases in the order of walking, bicycle, and electric scooter. A person who is riding on an electric scooter or a bicycle is likely to accelerate more suddenly than a pedestrian. Particularly, since an electric scooter includes a motor serving as a power source, the electric scooter is likely to accelerate more suddenly than a bicycle.

In a driving support function, it is necessary to reliably perform support such as deceleration or stopping before a support target or traveling to avoid the support target. On the other hand, when a sufficient distance to the support target, a sufficient time to collision, or the like can be maintained, curbing activation of unnecessary support is required for reducing discomfort or trouble of an occupant. When a person near the vehicle is walking, the moving speed is low and sudden acceleration is less likely to be performed. Accordingly, a distance threshold value with respect to a target person or a time-to-collision threshold value in driving support needs to be set to be relatively small. On the other hand, when a person near the vehicle is riding on an electric scooter or a bicycle, the moving speed is high and the person is more likely to accelerate suddenly. Accordingly, the distance threshold value with respect to a target person or the time-to-collision threshold value in driving support needs to be set to be relatively large. A movement type of a person near the vehicle needs to be determined to set such threshold values and to effectively perform the driving support function. Determination thereof is performed by the movement type determination device 100.

The camera 2 is provided to monitor surroundings (for example, a front view, a side view, or a rear view) of the vehicle 1. The camera 2 transmits an image acquired by imaging the surroundings of the vehicle 1 to the movement type determination device 100 and the driving support device 3. The surroundings of the vehicle 1 may be monitored using a sensor such as a radar or a Lidar (Light Detection and Ranging) that detects an object near the vehicle 1 instead of the camera 2.

The driving support device 3 is a driving support device that includes an electronic control unit (ECU) and an actuator and supports at least one of driving, steering, and braking of the vehicle 1. The driving support device 3 estimates a current position or a current speed of a target person or a future position or a future speed of the target person based on the movement type of the target person determined by the movement type determination device 100 and a position of the target person detected by the camera 2 and performs driving support to avoid collision with the target person. The driving support device 3 performs driving support for the target person based on the information indicating that the distance from the vehicle 1 to the target person or the time to collision is less than the distance threshold value or the time-to-collision threshold value. When the target person is walking, the driving support device 3 sets the distance threshold value with respect to the target person or the time-to-collision threshold value to be relatively small. On the other hand, when the target person is riding on a vehicle, the driving support device 3 sets the distance threshold value with respect to the target person or the time-to-collision threshold value to be relatively large.

Configuration of Movement Type Determination Device 100

The movement type determination device 100 is constituted by one or more computers. The computer includes a central processing unit (CPU), a read only memory (ROM), a random access memory (RAM), an input port, and an output port. The movement type determination device 100 is realized by installing a program for causing the computer to serve as the movement type determination device 100 in the computer. The program is stored in a storage medium. The movement type determination device 100 transmits and receives data to and from constituents of the vehicle 1 by communicating with the constituents via the input port and the output port. Particularly, the movement type determination device 100 receives an image from the camera 2 or transmits a determination result of a movement type of a nearby person to the driving support device 3.

The movement type determination device 100 includes a feature portion detecting unit 101, a time-series data acquiring unit 102, a feature value extracting unit 103, and a movement type determining unit 104 as functional units.

The feature portion detecting unit 101 detects a feature portion of a target person appearing in an image captured by the camera 2. A feature portion is a portion which is preset as a portion representing specific oscillation at the time of movement of the target person, and examples thereof include a head, a neck, an eye, a nose, a shoulder, and a hand. Extraction of a feature portion is performed, for example, by pattern matching with an image indicating the feature portion and stored in advance in a storage unit. Alternatively, extraction of a feature portion may be performed using a trained model which has been trained using a plurality of images representing the feature portion as training data in advance.

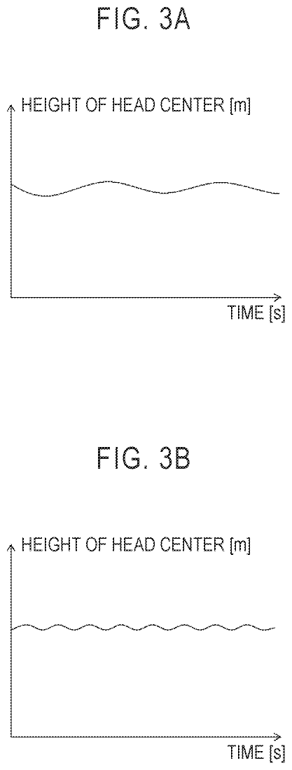

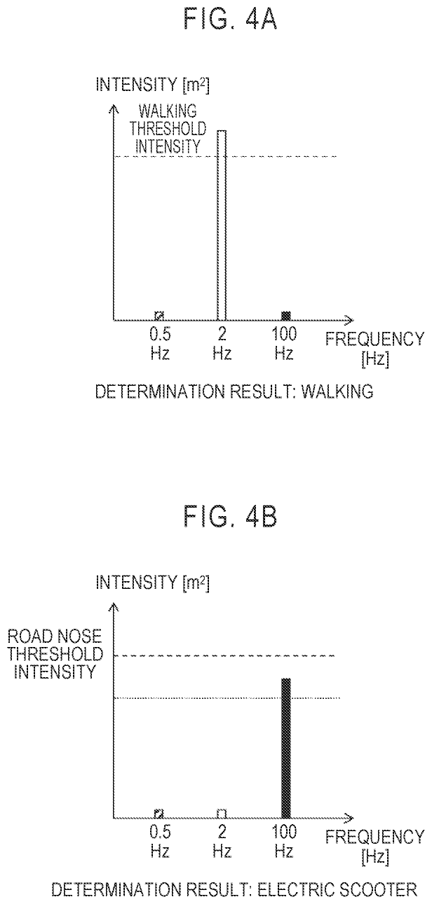

A feature portion of a target person and oscillation thereof will be described below with reference to FIGS. 2A, 2B, 3A, and 3B. In this example, the head is used as an example of a feature portion of a target person 4. In the example illustrated in FIG. 2A, the target person 4 is walking, and a head center 5 oscillates vertically based on a walking motion. Time-series data of a position of the head center 5 in this case is illustrated in FIG. 3A. In the example illustrated in FIG. 2B, the target person 4 is moving on an electric scooter 6 which is an example of a vehicle, and the head center 5 is oscillating vertically based on road noise. Time-series data of the position of the head center 5 in this case is illustrated in FIG. 3B. It can be seen that the oscillation based on walking illustrated in FIGS. 2A and 3A is slower at a lower frequency (with a longer period) than the oscillation based on road noise illustrated in FIGS. 2B and 3B. As described above, a feature portion of a target person oscillates specifically according to a state in which the target person is walking or a state in which the target person is riding on a vehicle.

Description will be continued with reference back to FIG. 1. The time-series data acquiring unit 102 acquires time-series data of a position or a speed of a feature portion. Time-series data of the position of the feature portion is acquired by detecting the feature portion in a plurality of images acquired at intervals of a predetermined imaging cycle by the camera 2 and acquiring the position thereof. Time-series data of the speed of the feature portion is acquired by acquiring a change of the position of the feature portion detected in the plurality of images. The graphs illustrated in FIGS. 3A and 3B are examples of the acquired time-series data.

The feature value extracting unit 103 extracts a feature value of a predetermined frequency component or a predetermined frequency band which is specific to the movement type to be determined from the time-series data acquired by the time-series data acquiring unit 102. In this embodiment, the feature value extracting unit 103 acquires intensities of three types of frequency components including a walking frequency component which is a frequency specific to oscillation of the feature portion based on the walking motion, a road noise frequency component which is a frequency specific to oscillation based on road noise, and a pedaling motion frequency component which is a frequency specific to a pedaling motion of pedaling a bicycle.

The walking frequency component is a frequency component specific to vertical oscillation of the head center 5 at the time of walking. Referring to studies of the inventor and the like, vertical oscillation at the time of walking occurs at a frequency of about 1 Hz to 2 Hz. In this embodiment, an intensity of a frequency component at 2 Hz is acquired as the walking frequency component.

The road noise frequency component is a frequency component specific to vertical oscillation based on road noise when a target person is moving on an electric scooter or a bicycle. Referring to studies of the inventor and the like, vertical oscillation based on road noise occurs at a frequency of about 50 Hz to 500 Hz. In this embodiment, an intensity of a frequency component at 100 Hz is acquired as the road noise frequency component.

The pedaling motion frequency component is a frequency component specific to vertical oscillation based on pedaling motion when a target person is moving on a bicycle. Referring to studies of the inventor and the like, vertical oscillation based on a pedaling motion occurs at a frequency of about 0.3 Hz to 0.8 Hz. In this embodiment, an intensity of a frequency component at 0.5 Hz is acquired as the pedaling motion frequency component. The vehicle in this case may be a vehicle using a pedaling motion of a person as power other than a bicycle. The “vehicle using a pedaling motion of a person as power” is a vehicle using a pedaling portion of a person as power. For example, a motion of a person pedaling on pedals or pedaling a manual handle is necessary for a vehicle such as a tricycle or a wheelchair. Similarly to a bicycle, a pedaling motion frequency component appears in a “vehicle using a pedaling motion of a person as power.”

In this embodiment, it is determined whether a movement type of a target person is movement using a “vehicle using a pedaling motion of a person as power.” Determination of a “vehicle using a pedaling motion of a person as power” (for example, a bicycle, a tricycle, or a wheelchair) is performed, for example, by pattern matching with an image indicating a vehicle stored in advance in a storage unit. Alternatively, the determination of such a vehicle may be performed using a trained model which has been trained using a plurality of images representing the vehicle as training data in advance.

The pedaling motion frequency component does not appear in case of a vehicle other than a “vehicle using a pedaling motion of a person as power.” For example, this is because a power source of an electric scooter is a motor and thus a periodic motion such as a motion of pedaling a bicycle does not occur. This is also suitable for a vehicle with a power source other than an electric scooter. For example, similarly to an electric scooter, a pedaling motion frequency component does not appear in case of vehicles such as a bicycle with a motor and an electric wheelchair other than the “vehicle using a pedaling motion of a person as power.” Here, a road noise frequency component appears in this case.

In this embodiment, it is determined whether a movement type of a target person is movement using a vehicle other than a “vehicle using a pedaling motion of a person as power.” Determination of a vehicle other than a “vehicle using a pedaling motion of a person as power” (for example, an electric scooter, a bicycle with a motor, or an electric wheelchair) is performed, for example, by pattern matching with an image indicating a vehicle stored in advance in a storage unit. Alternatively, the determination of such a vehicle may be performed using a trained model which has been trained using a plurality of images representing the vehicle as training data in advance.

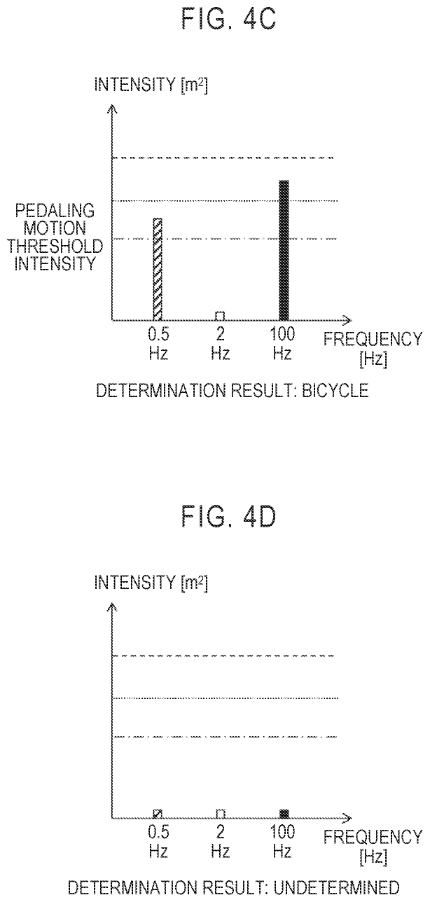

The feature value extracting unit 103 acquires intensities of the walking frequency component, the road noise frequency component, and the pedaling motion frequency component in the time-series data acquired by the time-series data acquiring unit 102. Acquisition of an intensity of a frequency component is performed, for example, in various existing aspects such as Fourier transform. Graphs of the acquired intensities of the frequency components are illustrated in FIGS. 4A to 4D. 2 Hz denotes a walking frequency component, 100 Hz denotes a road noise frequency component, and 0.5 Hz denotes a pedaling motion frequency component.

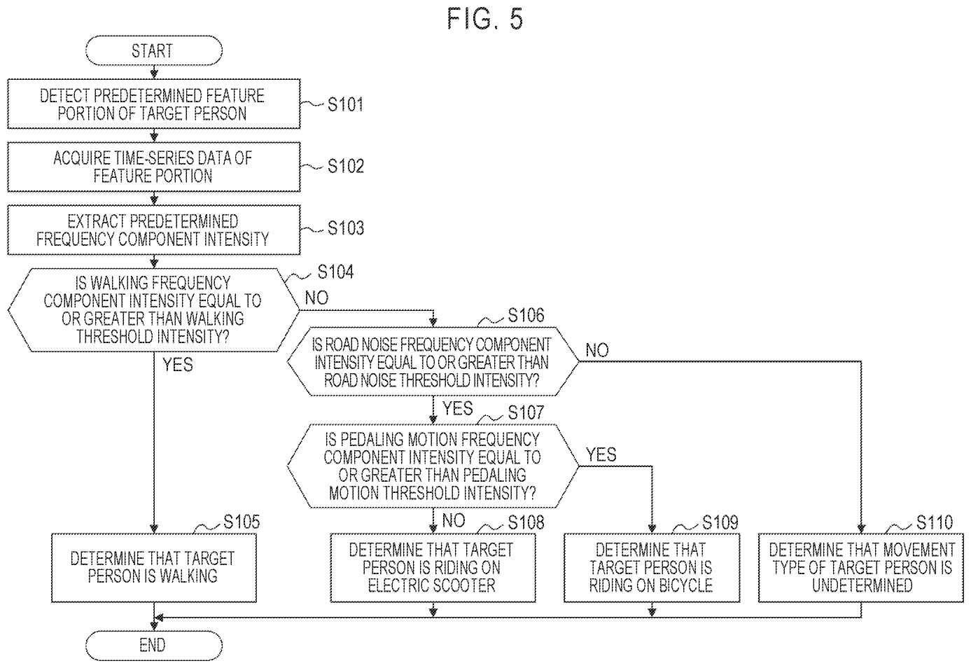

The movement type determining unit 104 determines the movement type of the target person 4 based on the frequency component acquired by the feature value extracting unit 103. The movement type of the target person 4 includes four types of walking (S105 in FIG. 5), an electric scooter (S108), a bicycle (S109), and undetermined (S110). The movement type determining unit 104 determines which thereof the movement type of the target person 4 is.

A routine of processes which are performed by the feature portion detecting unit 101, the time-series data acquiring unit 102, the feature value extracting unit 103, and the movement type determining unit 104 will be described below with reference to the flowchart illustrated in FIG. 5.

First, in Step S101, the feature portion detecting unit 101 detects a feature portion of a target person appearing in an image captured by the camera 2. Then, in Step S102, the time-series data acquiring unit 102 acquires time-series data of the position of the feature portion from the position of the feature portion detected in each of the plurality of images acquired at intervals of a predetermined imaging cycle by the camera 2. Then, in Step S103, the feature value extracting unit 103 acquires a predetermined frequency component intensity in the time-series data acquired in Step S102.

In Step S104, the movement type determining unit 104 determines whether the intensity of a walking frequency component is greater than a walking threshold intensity. The walking threshold intensity is a threshold intensity which is predetermined for a walking frequency component. When the intensity of the walking frequency component is equal to or greater than the walking threshold intensity (Step S104: YES), the movement type determining unit 104 determines that the target person is walking in Step S105.

On the other hand, when it is determined that the intensity of the walking frequency component is less than the walking threshold intensity (Step S104: NO), the movement type determining unit 104 determines that the target person is not walking, and the routine proceeds to Step S106.

In Step S106, the movement type determining unit 104 determines whether an intensity of a road noise frequency component is greater than a road noise threshold intensity. The road noise threshold intensity is a threshold intensity which is predetermined for a road noise frequency component. When the intensity of the road noise frequency component is equal to or greater than the road noise threshold intensity (Step S106: YES), the routine proceeds to Step S107.

In Step S107, the movement type determining unit 104 determines whether an intensity of a pedaling motion frequency component is greater than a pedaling motion threshold intensity. The pedaling motion threshold intensity is a threshold intensity which is predetermined for the pedaling motion frequency component. When the intensity of the pedaling motion frequency component is less than the pedaling motion threshold intensity (Step S107: NO), the movement type determining unit 104 determines that the target person is riding on an electric scooter in Step S108. On the other hand, when the intensity of the pedaling motion frequency component is equal to or greater than the pedaling motion threshold intensity (Step S107: YES), the movement type determining unit 104 determines that the target person is riding on a bicycle in Step S109.

When the intensity of the road noise frequency component is less than the road noise threshold intensity (Step S106: NO), the movement type determining unit 104 determines that the movement type of the target person is undetermined in Step S110.

Determination results in FIGS. 4A to 4D will be specifically described below.

In the case of FIG. 4A, the intensity of the walking frequency component (2 Hz) is equal to or greater than the walking threshold intensity (Step S104: YES). Accordingly, the movement type determining unit 104 determines that the target person is walking in the case of FIG. 4A in Step S105.

In the case of FIG. 4B, the intensity of the walking frequency component (2 Hz) is less than the walking threshold intensity (Step S104: NO), the intensity of the road noise frequency component (100 Hz) is equal to or greater than the road noise threshold intensity (Step S106: YES), and the intensity of the pedaling motion frequency component (0.5 Hz) is less than the pedaling motion threshold intensity (Step S107: NO). Accordingly, in Step S108, it is determined that the target person is riding on an electric scooter in the case of FIG. 4B.

In the case of FIG. 4C, the intensity of the walking frequency component (2 Hz) is less than the walking threshold intensity (Step S104: NO), the intensity of the road noise frequency component (100 Hz) is equal to or greater than the road noise threshold intensity (Step S106: YES), and the intensity of the pedaling motion frequency component (0.5 Hz) is equal to or greater than the pedaling motion threshold intensity (Step S107: YES). Accordingly, in Step S109, it is determined that the target person is riding on a bicycle in the case of FIG. 4C.

In the case of FIG. 4D, the intensity of the walking frequency component (2 Hz) is less than the walking threshold intensity (Step S104: NO), and the intensity of the road noise frequency component (100 Hz) is less than the road noise threshold intensity (Step S106: NO). Accordingly, in Step S110, the movement type determining unit 104 determines that the movement type of the target person is undetermined in the case of FIG. 4D.

By performing the aforementioned routine of processes, the movement type determination device 100 according to this embodiment can determine which of four types including walking (S105), an electric scooter (S108), a bicycle (S109), and undetermined (S110) the movement type of the target person 4 is.

The movement type determination device 100 transmits the determination result of the movement type of the target person 4 to the driving support device 3. The driving support device 3 sets the distance threshold value or the time-to-collision threshold value in driving support based on the determination result of the movement type. The driving support device 3 performs driving support based on the threshold values. The driving support device 3 performs driving support for a target person based on information indicating that the distance from the vehicle 1 to the target person or the time to collision is less than the threshold value. For example, it is possible to perform support such that the vehicle decelerates or stops before a target person or travels to avoid the target person.

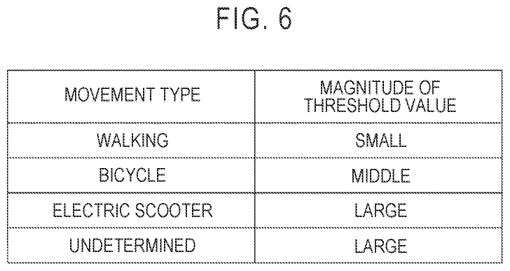

As described in the table illustrated in FIG. 6, the driving support device 3 determines the magnitude of the threshold value based on the determination result of a movement type of a target person. When the determination result of a movement type is “walking,” the threshold value is set to “small.” When the target person 4 is walking, the moving speed is low and the target person 4 is less likely to accelerate suddenly. Accordingly, the threshold value is set to “small” such that unnecessary support is avoided.

When the determination result of a movement type is a “bicycle,” the threshold value is set to “middle.” When the target person 4 is riding on a bicycle, the moving speed is higher than a pedestrian and the bicycle is more likely to accelerate suddenly. Accordingly, the threshold value is set to “middle” such that support functions appropriately.

When the determination result of a movement type is an “electric scooter” or “undetermined,” the threshold value is set to “large.” When the target person 4 is riding on an electric scooter, the moving speed is higher than a pedestrian or a bicycle and the electric scooter is more likely to accelerate suddenly. Accordingly, the threshold value is set to “large” such that support functions appropriately. When the determination result of a movement type is undetermined, it cannot be predicted how the target person moves and thus the threshold value is set to “large” such that support easily functions appropriately.

According to the aforementioned embodiment, it is possible to determine the movement type of the target person and to provide driving support based on the determination result. When a movement type is determined, a predetermined feature portion which is a part of the target person is detected instead of performing image processing on the entire region in which a person appears unlike the related art, and thus a processing load in determining the movement type can be reduced. When a part of a target person is covered with a certain object but a predetermined feature portion such as the head is not covered, it is possible to determine the movement type. Accordingly, according to this embodiment, it is possible to appropriately determine whether a person is walking or whether the person is riding on a vehicle.

### MODIFIED EXAMPLES

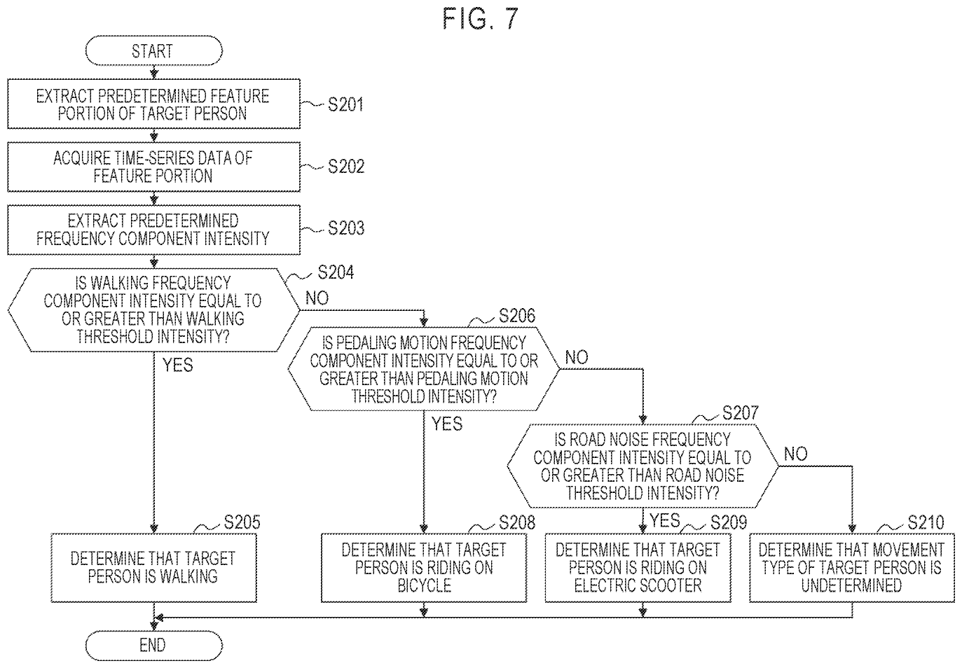

In this embodiment, determination of a walking frequency component intensity in Step S104, determination of a road noise frequency component intensity in Step S106, and determination of a pedaling motion frequency component intensity in Step S107 are performed in this order, but this order may be appropriately changed. FIG. 7 is a flowchart illustrating an example when the determination order is changed (description of the same or corresponding steps as in the flowchart illustrated in FIG. 5 will be omitted). The flowchart illustrated in FIG. 7 is different from the flowchart illustrated in FIG. 5 in that the order of determination of a road noise frequency component intensity and determination of a pedaling motion frequency component intensity is exchanged. That is, in Step 5206, the movement type determining unit 104 determines whether the intensity of the pedaling motion frequency component is equal to or greater than the pedaling motion threshold intensity. When the intensity of the pedaling motion frequency component is equal to or greater than the pedaling motion threshold intensity (Step S206: YES), the movement type determining unit 104 determines that the target person is riding on a bicycle in Step S208. On the other hand, when the intensity of the pedaling motion frequency component is less than the pedaling motion threshold intensity (Step S206: NO), the routine proceeds to Step S207. In Step S207, the movement type determining unit 104 determines whether the intensity of the road noise frequency component is equal to or greater than the road noise threshold intensity. When the intensity of the road noise frequency component is equal to or greater than the road noise threshold intensity (Step S207: YES), the movement type determining unit 104 determines that the target person is riding on an electric scooter in Step S209.

Unlike the flowcharts illustrated in FIGS. 5 and 7, determination of a road noise frequency component intensity (Step S106 in FIG. 5) may be performed before determination of a walking frequency component intensity (Step S104 in FIG. 5) is performed. In this case, when the determination result of the road noise frequency component intensity (Step S106 in FIG. 5) is NO, determination of the walking frequency component intensity (Step S104 in FIG. 5) is performed. Alternatively, the determinations may be performed in another order.

In this embodiment, the head center 5 is used as a feature portion of a target person, but the feature portion may be a part other than the head. For example, a neck, an eye, a nose, a shoulder, or a hand may be used. Regarding the feature portions other than the head center 5, determination of a movement type can be performed in the same way as in case of the head center 5. In this embodiment, when the head cannot be detected due to certain circumstances, the determination of a movement type may be performed using another feature portion. For example, when the head is covered with an object such as a sign or when a target person wears a helmet and pattern matching has failed, the head cannot be detected. In this case, the determination of a movement type may be performed using a shoulder as the feature portion instead of the head. Similarly, when no shoulder can be detected, the determination of a movement type may be performed using a hand as the feature portion.

In this embodiment, an intensity of a frequency component is used as a feature value indicating an oscillation state, but another feature value may be used. For example, a value obtained by integrating the intensity of a frequency component over a predetermined frequency band may be used as the feature value. Referring to the studies of the inventor and the like, vertical oscillation at the time of walking occurs at a frequency of about 1 Hz to 2 Hz, vertical oscillation based on road noise occurs at a frequency of about 50 Hz to 500 Hz, and vertical oscillation based on a pedaling motion occurs at a frequency of about 0.3 Hz to 0.8 Hz. Values obtained by integrating the intensities of the frequency components in such frequency ranges may be used as the feature value.

In this embodiment, time-series data of a position or a speed in the vertical direction of a predetermined feature portion of a target person is acquired, but time-series data of a position or a speed in a horizontal direction may be acquired. Oscillation when a person is walking or riding on a vehicle is not ideal oscillation in the vertical direction, but is actually oscillation in an oblique direction. Accordingly, a component of oscillation of a position or a speed in the horizontal direction is also generated to correspond to oscillation of the position or the speed in the vertical direction. Time-series data of the position or speed in the horizontal direction may be acquired.

While an embodiment of the disclosure and modified examples thereof have been described above, the disclosure is not limited thereto. The disclosure can be realized in various forms including various modifications and improvements based on knowledge of those skilled in the art in addition to the embodiment.

What is claimed is:

1. A person movement type determination method comprising:
acquiring time-series data of a position or a speed of a predetermined feature portion which is a part of a body of a target person;
extracting a feature value of a predetermined frequency component or a predetermined frequency band based on oscillation of the predetermined feature portion indicating a movement type to be determined from the time-series data; and
determining whether a movement type of the target person is that which is to be determined based on the feature value.

2. The person movement type determination method according to claim 1, wherein the movement type of the target person to be determined is movement by walking,
wherein the feature value is a first feature value which is a feature value of the predetermined frequency component or the predetermined frequency band specific to oscillation of the predetermined feature portion based on a walking motion, and
wherein it is determined that the movement type of the target person is movement by walking when the first feature value is greater than a predetermined first threshold value and it is determined that the movement type of the target person is not movement by walking when the first feature value is less than the first threshold value.

3. The person movement type determination method according to claim 1, wherein the movement type of the target person to be determined is movement by vehicle,
wherein the feature value is a second feature value which is a feature value of the predetermined frequency component or the predetermined frequency band specific to oscillation of the predetermined feature portion based on road noise at the time of movement by vehicle, and
wherein it is determined that the movement type of the target person is movement by vehicle when the second feature value is greater than a predetermined second threshold value and it is determined that the movement type of the target person is not movement by vehicle when the second feature value is less than the second threshold value.

4. The person movement type determination method according to claim 1, wherein the movement type of the target person to be determined is movement by vehicle using a pedaling motion of the target person as power,
wherein the feature value is a third feature value which is a feature value of the predetermined frequency component or the predetermined frequency band specific to oscillation of the predetermined feature portion based on a motion of pedaling the vehicle of the target person, and
wherein it is determined that the movement type of the target person is movement by vehicle using the pedaling motion of the target person as power when the third feature value is greater than a predetermined third threshold value and it is determined that the movement type of the target person is not movement by vehicle using the pedaling motion of the target person as power when the third feature value is less than the third threshold value.

5. A person movement type determination device comprising:
an acquisition unit configured to acquire time-series data of a position or a speed of a predetermined feature portion which is a part of a body of a target person;
an extraction unit configured to extract a feature value of a predetermined frequency component or a predetermined frequency band based on oscillation of the predetermined feature portion indicating a movement type to be determined from the time-series data; and
a determination unit configured to determine whether a movement type of the target person is that which is to be determined based on the feature value.

6. A non-transitory storage medium that stores a person movement type determination program causing a computer to perform:
acquiring time-series data of a position or a speed of a predetermined feature portion which is a part of a body of a target person;
extracting a feature value of a predetermined frequency component or a predetermined frequency band based on oscillation of the predetermined feature portion indicating a movement type to be determined from the time-series data; and
determining whether a movement type of the target person is that which is to be determined based on the feature value.
